(19) United States
(12) Patent Application Publication
(10) Pub. No.: US 2005/0223099 A1
(43) Pub. Date: Oct. 6, 2005

(54) Image display system

(76) Inventors: Toshiyuki Morita, Kawasaki (JP); Shinya Iguchi, Kawasaki (JP); Hirofumi Nagano, Kawasaki (JP); Yukari Katayama, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/067,688

(22) Filed: Mar. 1, 2005

(30) Foreign Application Priority Data
Mar. 2, 2004 (JP) 2004-056988

(51) Int. Cl. G06F 15/16

(52) U.S. Cl. 709/227; 709/204; 709/219

(57) ABSTRACT

A display system includes, a server for transmitting data to a map information display device to cause the character to be displayed on a detail information display screen, the map information display device for starting move display animation of the character and transmitting data indicative of move completion to the server, the server for transmitting data to a detail information display device to display the detail information about the shop to which the character is snapped and also transmitting data to display the character on the detail information display screen, the detail information display device for displaying the received detail information about the shop, causing the character to log in on the detail information display screen and to be displayed thereon, and continuously reproducing the move display animation of the character until the character reaches a character display area.

The present application claims priority from Japanese application JP2004-056988 filed on Mar. 2, 2004, the content of which is hereby incorporated by reference into this application.

### BACKGROUND OF THE INVENTION

The present invention relates to systems having a plurality of display devices and more particular, to a system for moving and displaying an object such as a character on a plurality of display screens including a map information display indicative of a peripheral map and a shop or the like and a detail information display indicative of detail information about the shop, by a user who utilizes his portable telephone.

JP-A-7-84725 discloses an example of multi-display systems in which a position definition table for previously defining one of a plurality of display screens to be moved when a cursor is directed outwards of one display screen is provided, and the cursor can be easily moved on the plurality of display screens positioned at given positions by referring to the position definition table.

The above system, in summary, includes the plurality of displays located at given positions, a position definition file for defining any one of the display screens to be moved when the cursor is directed and instructed outward of the current screen, and a cursor display means, in response to an instruction to move the cursor on one of the display screens, for referring to the position definition file and shifting the cursor to the corresponding screen and displaying it when the cursor is directed outward of an end of the screen.

A contents providing system for enabling an object included in contents to be moved between presenting apparatuses and displayed thereon, a contents receiver, a contents providing method, a contents receiving method, a contents providing program, and a contents receiving program are described in JP-A-2003-333563.

When summarized, the above contents providing system for providing contents in a contents presenting environment includes a first presenting apparatus (TV display) for presenting the contents in the form of video and/or audio and a second presenting apparatus (terminal, stuffed toy, automatic musical instrument) other than the first presenting apparatus. And the system is characterized by providing information about the object (character, musical instrument) included in the contents to be moved to the second presenting apparatus and be presented thereon.

In the multi-display system disclosed in JP-A-7-84725, even when a cursor on one display screen is moved to another display screen, the plurality of displays are controlled by a single computer. For this reason, when it is desired to display information requiring high processing performance such as moving picture display or real-time video broadcast, most of the computer processing ability is required to be allocated to the screen display, which affects the entire processing performance of the computer main body.

When such contents that a cursor or a character as an object is frequently moved here and there is displayed on the plurality of display screens, and when the aforementioned system having an arrangement of controlling the plurality of displays with the single computer is employed; it is difficult to make the control operation of adjusting display between the plurality of displays independent of the contents displaying operation of each display. Thus this also exerts an influence upon the development efficiency.

In the contents providing system, contents receiver, contents providing method, contents receiving method, contents providing program, and contents receiving program disclosed in JP-A-2003-333563; there is provided a method for shifting such an object as a character from the first display device such as a TV display to a second display device such as a terminal or an automatic instrument and for presenting the character thereon. That is, it is possible to shift the character from the first display device to the second display device and to display the character thereon.

However, it is impossible to inform the first display device of the display state of the character on the second display device and, the first display device cannot display the character on the second display device or on a third display device other than the second device according to the display state of the received character. In other words, it is impossible to display the character in association with the plurality of display devices while establishing bidirectional communication of the display state of the character between the plurality of display devices.

### SUMMARY OF THE INVENTION

It is an object of the present invention to provide a multi-display-screen display system which displays information in association with the display screens of a plurality of display devices having a display control function, and also to provide a screen display method which can move and display an object such as a character while establishing communication of the display state of the character between the plurality of display devices.

In accordance with the present invention, when a server receives operational contents from a user via his operation over his portable terminal such as a portable telephone or a PDA, the server transmits to a first display device a display instruction relating to an object such as a character on the operational contents, e.g., to shift the object from the display screen currently being displayed to another display screen. Whereas, the first display device calculates information necessary for the operational display of the object on the basis of the received display instruction relating to the operation of the object, e.g., calculates the type of operational animation of the object, information about the position of the character movement destination or the like. The first display device displays the motion of the object on the screen of the first display device on the basis of the calculated information necessary for the operational display of the object. And after the operational display of the object is completed, the first display device transmits an operation completion notification to the server.

When the server transmits or receives data relating to the operations of the display devices and object, more specifically when the object is shifted from the first display device to the second display device and displayed thereon, the motion display of the object of the second display device is started after the motion display of the object on the first display device is completed. In this manner, the object can be operated and displayed in association with the plurality of display devices.

In accordance with the present invention, the server transmits information relating only to the operation of the object to be displayed on the plurality of the display devices, and the associated display device operates and displays the object on the screen of the display device on the basis of the received display instruction relating to the operation of the object. As a result, the server is only required to instruct the display device about the operation of the object, and thus the processing load of the server on the screen displaying operation of the object and so on in the display device can be reduced.

In accordance with the present invention, since the server is only required to instruct the display device about the operation of the object and so on, the control operation of the server for adjusting the display between the plurality of display devices can be easily made independent of the displaying operation of an object (contents) such as a character on the screen of each display device. Thus, even when the screens of the plurality of display devices having different performances are employed, or even when the replacement of the display device or devices causes variations of the inherent performances of the display devices such as the size of the display screen or the plotting speed of the display device; the need for modifying the program in the server side can be eliminated, because the displaying operation of each display device is made independent of the displaying operation of the server with respect to the contents display on the screens of the display devices.

In accordance with the present invention, after the operational display of contents such as an object in first one of a plurality of display devices is completed, the first display device can transmit its operation completion notification to the server. As a result, the server can instruct a second display device to display the operation of an object such as a character according to the situation of the display operation of the object on the first display device.

In accordance with the present invention, when it is desired to display information on the display contents of the first display device on the second display device, the object is moved on the display screen of the first display device as far as a side of the display screen of the first display device at which side the second display device is installed. Thus the user can easily recognize the second display device on which the information about the display contents of the first display device is to be displayed.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows a processing flow chart for displaying detail information about a shop on a detail information display screen using a character on a map information display screen in a portable telephone, a server, a map information display device, and detail information display device in accordance with an embodiment of the present invention;

FIG. 2 shows a schematic arrangement of the portable telephone, server and display device in the present invention;

FIG. 3A shows an example of a list of display devices in the embodiment;

FIG. 3B shows an example of a list of shops in the embodiment;

FIG. 3C shows an example of a list of character numbers in the embodiment;

FIG. 4 schematically shows a processing flow chart for displaying a shop on the map information display screen in the server and the map information display device in the present embodiment;

FIG. 5 schematically shows a processing flow chart for moving and displaying a character on the map information display screen in the portable telephone, server and map information display device of the present embodiment;

FIG. 6 shows an example of the map information display screen in the embodiment; and

FIG. 7 shows an example of the detail information display screen in the embodiment.

### DETAILED DESCRIPTION OF THE EMBODIMENTS

An embodiment of the present invention will be described in detail with reference to the accompanying drawings.

In the present embodiment, a map information display screen (main screen) for displaying a peripheral map of a location such as a station or a department store where many people come together as well as a detail information display screen (sub screen) for displaying detail information of a shop displayed on the map information display screen are installed in such a location. A user, by operating a character (as an object) indicative of the user displayed on the map information display screen using his portable telephone, moves the character from shop to shop on the map information display screen and displays detail information (associated with the map information) about favorite one of the shops on the detail information display screen. In place of the character, an icon may be employed.

However, the present invention is not limited to the above specific example.

The object may be image data indicative of a character or character data, or may be contents including an image and a character.

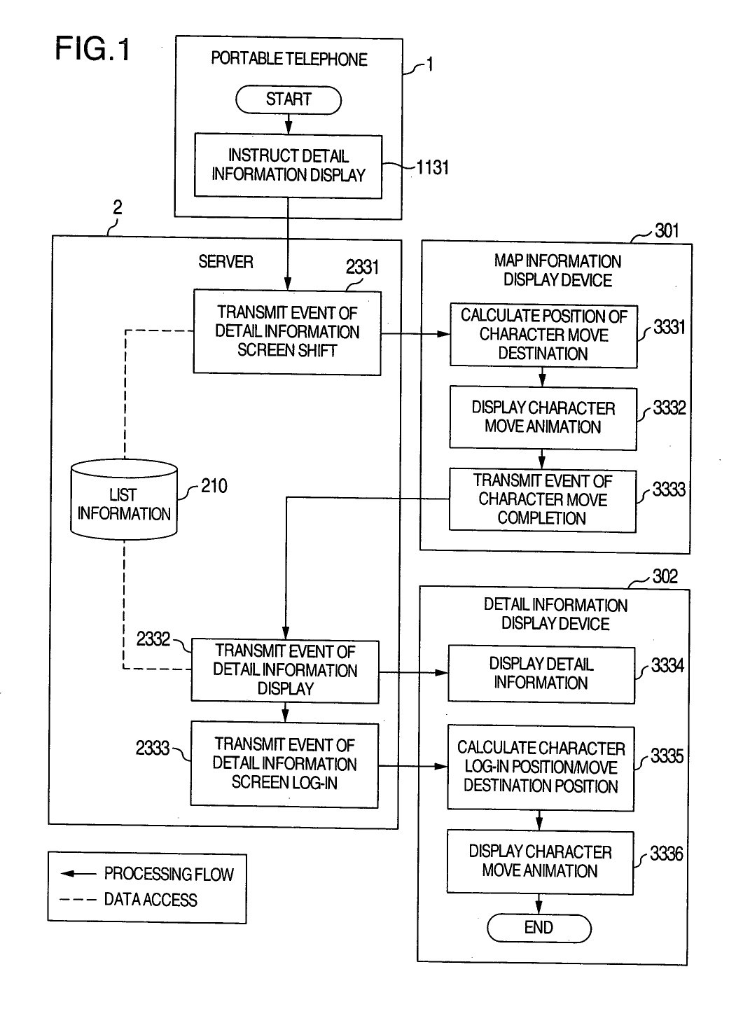

FIG. 1 shows a processing flow chart for displaying detail information about a shop to which a character indicative of the user displayed on the map information display device 301 is snapped, on a detail information display device 302 and for shifting the character on the map information display device 301 to the detail information display device 302 for display thereon, using user's portable telephone 1. The above ‘snapped character’ means that the character is displayed on the shop or in the vicinity thereof.

The above processing flow will be explained later.

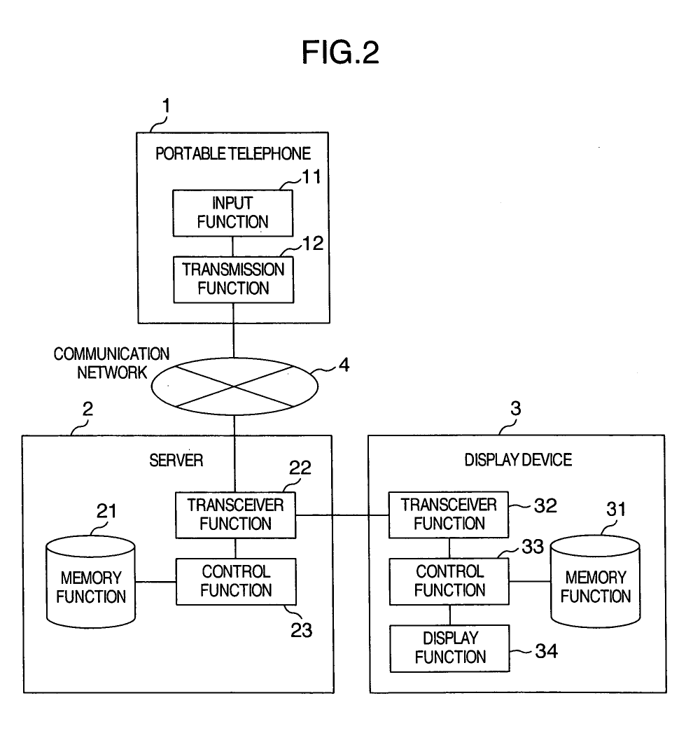

FIG. 2 shows hardware structures of the portable telephone 1, a server 2, and a display device 3 of the map information display device 301 or the detail information display device 302.

The portable telephone 1 is connected with the server 2 via a communication network 4, and the server 2 is connected with a single display device 3 or a plurality of the display devices 3.

The portable telephone 1 has an input function 11 for acquiring an input from the user using a crossed key for up/down/right/left input or using a numeral button, and also has a transmission function 12 for transmitting data entered into the input function 11 to the server.

In this connection, the portable telephone 1 may be replaced with a portable terminal such as a PDA or a notebook sized personal computer having the above functions.

The communication network 4 may be a public packet communication network, an analog line network, or a communication network utilizing infrared ray, Bluetooth, or local communication such as radio LAN.

The server 2 has a memory function 21 for storing data, a transceiver function 22 for transmitting or receiving data to or from the portable telephone 1 or display device 3, and a control function 23 for receiving the data from the portable telephone 1 or display device 3 and controlling the above functions to issue a screen display instruction to the display device 3.

The display device 3 has a memory function 31 for storing data, a transceiver function 32 for transmitting or receiving data to or from the server 2, a display function 34 for displaying information on video, character, character or the like on the display screen, and a control function 33 for transmitting or receiving data to or from the display device 3 and controlling the above functions to issue a screen display instruction to the display function 34.

For example, the display device 3 may be exclusive hardware having the aforementioned functions, or may be a general purpose product such as a personal computer.

In this connection, the server 2 may be held or stored in the interior of any of the plurality of the display devices 3 or be remotely connected with the display device 3 via the communication network.

The present embodiment includes the two display devices 3, that is, the map information display device for displaying map information and the detail information display device for displaying detail information about a shop. The both display devices are connected to the server 2 respectively.

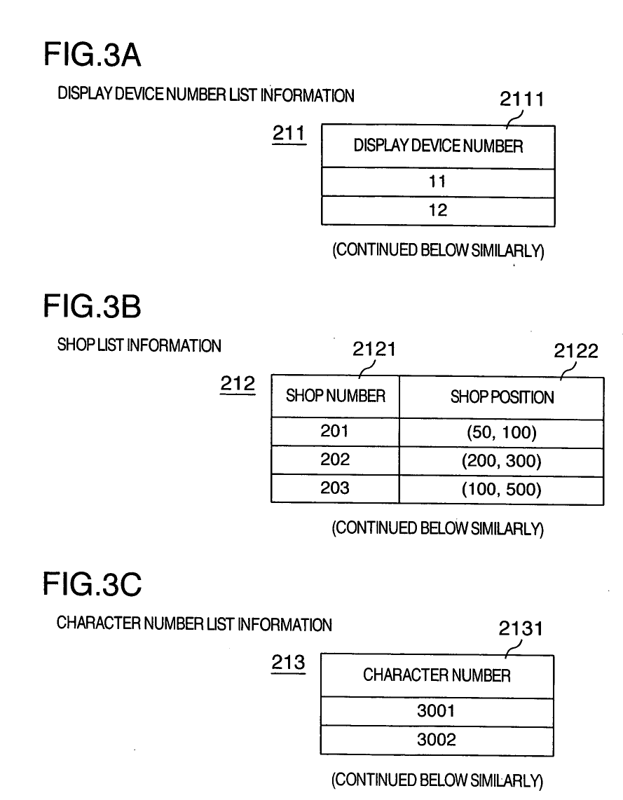

FIGS. 3A, 3B, and 3C show examples of list information 210 (see FIG. 1) stored in the memory function 21 of the server 2 in the present embodiment.

In FIG. 3A, display device number list information 211, which is used to manage the display devices 3 connected to the server 2, includes a display device number 2111.

The display device number 2111 indicative of a number for uniquely specifying the display device 3 is used when the server 2 transmits or receives data to or from the display device 3.

In first data contents of the example of FIG. 3A, the display device number 2111 indicative of the map information display device 301 has a number of 11. In second data contents of the example, the display device number 2111 indicative of the detail information display device 302 has a number of 12. For the map information display device 301, the detail information display device 302 may be provided by one or by a plurality of numbers (e.g., 2 or 4).

In FIG. 3B, shop list information 212, which is used to manage information on a shop displayed on the map display screen, includes a shop number 2121 and a shop position 2122.

The shop number 2121 denotes a number used to uniquely specify the shop displayed on the map display screen, and the shop position 2122 denotes positional data about the shop displayed on the map display screen.

For example, when the size of the display screen is defined by 1,280 pieces of pixels in a vertical direction and by 768 pieces of pixels in a horizontal direction, the shop position 2122 can be expressed in terms of coordinate data (positional information) of (0, 0) when the shop is located at an upper left corner of the display screen, or in terms of coordinate data of (1,280, 768) when the shop is located at an lower right corner of the display screen.

In first data contents of the example of FIG. 3B, the shop position 2122 is expressed in terms of coordinate data (50, 100) when the shop number 2121 has a number of 201.

The shop list information 212, when a peripheral map or a shop is displayed on the map information display screen upon system start, is transmitted from the server 2 to the display device 3 and stored in the memory function 31 of the display device 3.

In FIG. 3C, a character number list information 213, which is used to manage a character being displayed on the map information display screen or on the detail information display screen, includes a character number 2131.

The character number 2131 indicates a number for uniquely specify the character being displayed on the map information display screen or on the detail information display screen. A character corresponding to the user who operates the portable telephone 1 is allocated to the above character number.

In first data contents of the example of FIG. 3C, the character number 2131 indicative of a character corresponding to a user who operates a first portable telephone has a number of 3001; and the character number 2131 indicative of a character corresponding to a user who operates a second portable telephone has a number of 3002. In other words, it is preferable that different characters be allocated to different users.

The number of pieces of data managed by the character number list information 213 corresponds to the number of characters logged in on the screen, i.e., displayed on the screen of the display device 3.

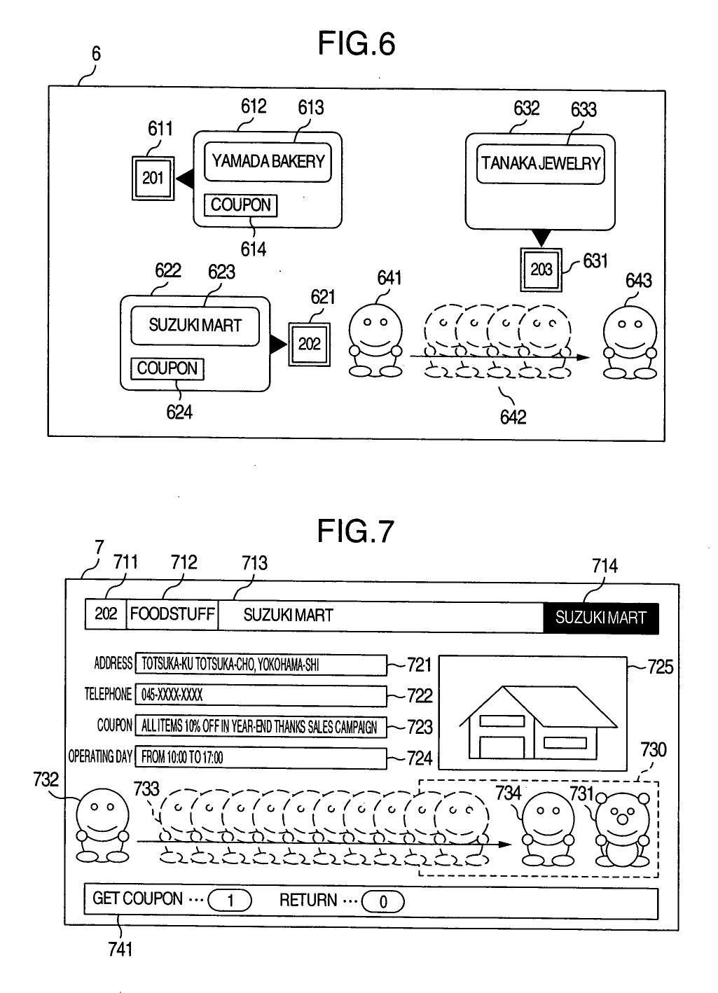

FIG. 6 shows an example of the map information display screen.

A peripheral map of the installed map information display device 301 is displayed on a map information display screen 6; and a shop, whose detail information can be displayed, is displayed by a shop block on the display screen.

The shop block includes, for example, a shop number, a shop name, and a coupon symbol indicative of presence or absence of a coupon issued from the shop.

A shop block given in the upper left part of FIG. 6 shows “Yamada Bakery” having a shop number 611, a shop name 613, and a coupon symbol 614 indicative of issuance of coupon from the shop.

In a shop information display area 612 of the above shop block, the shop name 613 and the coupon symbol 614 indicative of presence or absence of coupon issued from the shop are displayed. However, information about the shop other than the above may be displayed therein.

In the shop information display area 612, for example, a symbol or character information indicative of the fact that the shop is open or closed may be displayed. Or the color of the shop information display area may be changed. Or when the shop is open, the fact may be clearly identified by providing animation to a shop board.

When there is an advertisement information display screen for advertising the shop in addition to the map information display screen or the detail information display screen, a figure or character information indicative of the fact that “the shop is in advertisement” may be displayed on the shop information display area 612.

Or with respect to the shop whose detail information can be displayed on the detail information display screen, a figure or character information indicative of the fact that “the shop is displaying its detail information” may be displayed in the shop information display area 612.

A shop information display area can be displayed at the up, down, left or right side of a shop number. For the shop located in the upper left side of FIG. 6, the shop information display area 612 is given at the right side of the shop number 611. For a shop located in the lower left side of FIG. 6, a shop information display area 622 is displayed at the left side of a shop number 621.

In the illustrated example, a character moving around on the map display screen is located in the vicinity of the shop numbers and the shop information display areas.

For example, when the shop information display area 622 is given at the left side of the shop number 621 like the shop given in the lower left side of FIG. 6, a first character 641 can be located at the right side of the shop number, a second character can be located at the upper side thereof, and a third character can be located at the lower side thereof. In this case, the shop information display area 622 includes a shop number 623 and a coupon symbol 624; a shop information display area 632 includes a shop name 633; and the shop information display area 632 is given at the upper side of a shop number 631 indicated by a numeral 203.

When the character 641 is given as shown in FIG. 6 and when the detail information display screen is located at the right side of the map information display screen, user's operation of his portable telephone so as to display the detail information about the shop having a shop number of 202 causes the character 641 to be moved as shown by numeral 642. And when the character arrives at the right end of the display screen as shown by 643, the character disappears, from which time point the display of the character is shifted to the detail information display screen.

In other words, when it is desired to display the detail information on the detail information display screen, the character is required to be put in its no display state. Or in place of putting the character in the no display state, the character may be stopped at the move destination (at the right end of the screen) while the character remains displayed.

FIG. 7 shows an example of the detail information display screen.

In a detail information display screen 7, (a) detail information about the shop, (b) a character, (c) an operational guide for the portable telephone, and so on are displayed.

(a) With respect to the detail information on the shop, a shop number 711 indicates the shop in question, a shop type 712 indicates the category (e.g., foodstuff, clothing, or commodity) of the shop to which the shop belongs, a shop name 713 indicates the name of the shop, an address 721 indicates the address of the shop, a telephone 722 indicates a telephone number of the shop, a coupon 723 indicates detail information on the coupon when the shop issues the coupon, and an operating day 724 indicates information about operating or service days and service hours of the shop.

The above information may be of a character type or an image type.

Further, a shop logo mark 714 indicates a logo indicative of the shop, a detail image 725 indicates information such as a photograph when the appearance of the shop is taken, an image for the shop, video or image when the shop wants to display as the detail information.

(b) With respect to the character, the character when shifted from the map information display screen to the detail information display screen is left waiting and displayed there in a character display area 730.

In the case of FIG. 7, a character 731 operated by the user is already displaying the detail information on the shop. And when a character 732 operated by another user is shifted from the map information display screen to the current screen, moved as shown by reference numeral 733, and then arrives at an available space location as shown by 734; the character is left waiting and displayed there.

In this connection, a plurality of characters may be displayed on the detail information display screen to share the detail information display screen as in FIG. 7. Or only one character may be displayed in the detail information display screen to exclusively use the detail information display screen.

(c) With respect to the operational guide of the portable telephone, how to operate the portable telephone is expressed by character or image information as shown by numeral 741.

When the user operates the portable telephone 1 to display the detail information display screen while the character in the map information display screen is shifted and displayed, its operation includes three types of operations which follow.
(1) Displaying the map, shop, and so on
(2) Shifting and displaying the character between shops on the map information display screen
(3) Displaying detail information about the shop on the detail information display screen

The above operations (1) to (3) will be sequentially explained in detail.

(1) Displaying the Map, Shop, and So On

When the system is started, the server 2 transmits data necessary for displaying a map or a shop to the map information display device 301, which in turn displays it on the display screen.

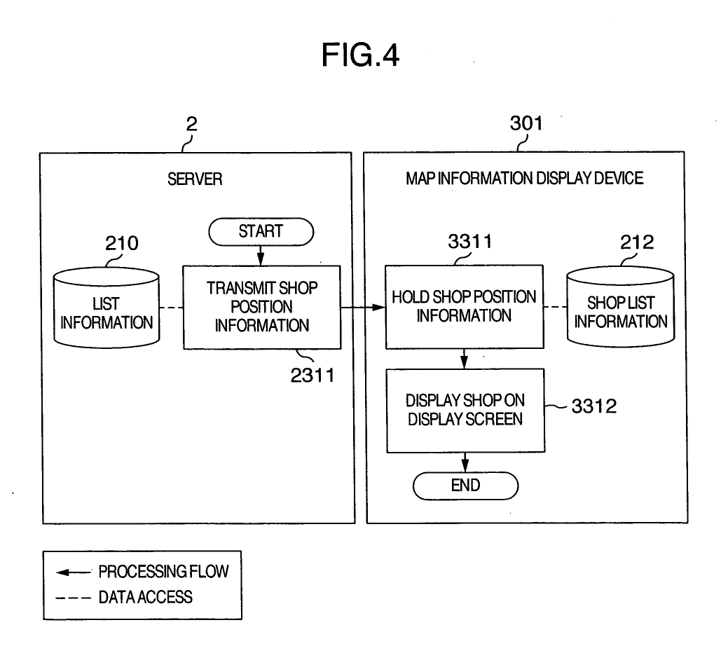

FIG. 4 shows a flow chart for the above.

In a step 2311, the server 2 acquires all data of the shop list information 212 from the list information 210 managed by the memory function 21 (see FIG. 2), and transmits the acquired data to the map information display device 301 using the transceiver function 22 (see FIG. 2).

The then data is transmitted as event information with a format of, e.g., (shop list information, (shop number A, shop position A), (shop number B, shop position B), . . . , and (shop number Z, shop position Z)).

Map image data to be displayed on the map information display device 301 and the storage destination location (e.g., URL, path name, etc.) of the map image data are also transmitted.

In a step 3311, the map information display device 301 acquires the above event information received from the server 2 using the transceiver function 32, and holds the information in the memory function 31 as the shop list information 212.

In a step 3312, the map information display device displays the map and shop on its display screen using the display function 34 (see FIG. 2) on the basis of the shop list information 212 and map image data acquired in the above step 3311.

Through the above steps, the map, shop, and so on can be displayed on the map information display screen.

In this connection, when it desired to display a screen number or a comment relating to the map information display screen in the header part of the map information display screen, when it is desired to display the operational guide of the portable telephone in the footer part of the map information display screen, or when it is desired to previously display other information on the map display screen; such information is transmitted as event information from the server 2 to the map information display device 301 in the step 2311, and the information is displayed on the map information display device 301 in the step 3312.

(2) Shifting and Displaying the Character Between Shops on the Map Information Display Screen

The user can log in on the map information display screen using the portable telephone and can move the character specified to the user between shops on the map information display screen.

In this case, it is assumed that, for enabling the user to operate the character on the map information display screen, an application (program) for character operation is already installed in the portable telephone 1.

Or the character can be operated by previously preparing a Web page for character operation in the server and by accessing the Web by the user.

As another method, the character may be operated by the user who sends a mail from his portable telephone to the server.

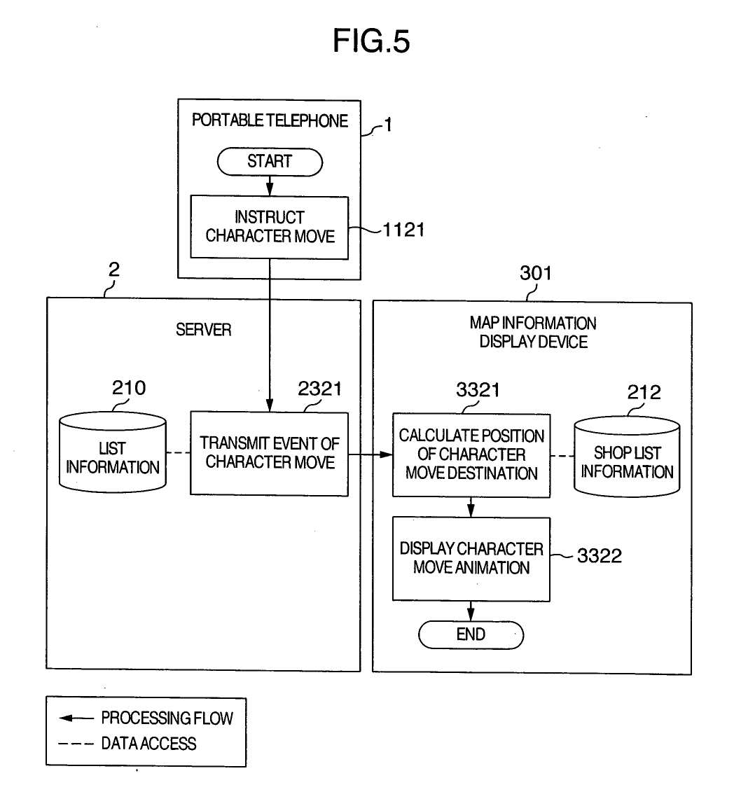

FIG. 5 shows a processing flow chart for the above.

In a step 1121, the user instructs the input function 11 (see FIG. 2) of the portable telephone 1 to operate the character by pushing a number key or a crossed key, and the transmission function 12 thereof transmits the entered key information to the server 2.

For example, operational types are previously allocated to keys of the portable telephone to generate events which follow. For example, the activation of the application installed in the portable telephone causes the character to log in on the map information display screen. Then pushing the crossed key (up/down/left/right) of the portable telephone causes the character to be moved to its upper-, lower-, left- or right-side shop. Pushing a number key “0” causes detail information about the shop having the character currently snapped thereto to appear on the detail information display screen. Pushing the left side of a soft key causes the character to log out from the map information display screen.

In this step, it is assumed that the application is started and the character indicative of the user is already displayed on the map information display screen. When any side of “up”, “down”, “left”, and “right” of the crossed key is pushed, the entered key information is transmitted to the server so that the character is moved to a shop located at the up, down, left or right side of the shop having the character currently snapped thereto by one shop and displayed therein.

In a step 2321, the transceiver function 22 (see FIG. 2) receives the input information sent from the portable telephone 1 and transmits an instruction corresponding to the character operation entered by the user from his portable telephone 1 to the map information display device 301 as event information.

However, it is assumed that, when the character first logs in on the map information display screen, the character number 2131 (see FIG. 3C) for uniquely specifying the character is allocated to the character, the memory function 21 adds it to the character number list information 213 in the list information 210 and transmits video data of the character to the map information display device 301, and the character is already displayed on the map information display screen.

When the key information acquired from the portable telephone 1 is from the crossed key (of up, down, left, and right) for moving the character between shops on the map information display screen, the character number list information 213 is first searched to acquire a character number corresponding to the user's character.

And the number of the shop to be next moved from the shop having the character currently snapped thereto is acquired from data on the number of the shop located at the up, low, left or right side of each shop.

For example, when the character is snapped to the shop having the shop number 201 (see FIG. 3B) and when the user operates the portable telephone so as to move the character to the “down”; “202” is acquired as the shop number of a shop for the character to be next moved to, if a shop located at the down side of the shop having a shop number of 201 has a shop number of 202 (see FIG. 3B).

The transceiver function 22 transmits the acquired character number and the shop number of the shop to be next moved to, to the map information display device 301.

At this time, the transmission data is transmitted as event information having a format (e.g., of character move, character number, shop number).

In a step 3321, the transceiver function 32 receives the event information relating to the character move from the server 2, and the shop list information 212 acquires positional data on the shop corresponding to the received shop number.

In this connection, if a display area for character snapping can be reserved at the up, low, left or right side of the shop number to be moved as shown in FIG. 6, then one of the up, down, left and right sides for character display is decided and coordinate data about a move destination is modified so that the currently-snapped character is not overlapped with the shop number.

For example, when the user wants to move the character to the right side of a shop number of 202 (see FIG. 3B) having a shop position of (200, 300), positional data about the move destination of the character is modified to (250, 300), if a difference from the shop number to display the character at the up, down, left or right side thereof is 50 pixels.

In a step 3322, the display function 34 (see FIG. 2) starts the move display animation of the character and the move display animation is continued until the character arrives at the move destination position acquired in the step 3321 from position to which the character is currently snapped.

Through the above steps, the character can be moved between shops and displayed on the map information display screen.

(3) Displaying Detail Information About the Shop On the Detail Information Display Screen

The user can display, on the detail information display screen, detail information about the shop having the character snapped thereto on the map information display screen and can shift the character on the map information display screen to the detail information display screen and display it thereon, using the portable telephone.

FIG. 1 shows a processing flow chart for the above.

In a step 1131, the user pushes a numeral key or a crossed key to instruct the character operation through the input function 11 of the portable telephone 1. And the transmission function 12 transmits the key information input from the transmission function 12 to the server 2.

In the present embodiment, the type of each key operation of the portable telephone is previously allocated to the key. For example, pushing a numeral key “0” causes detail information about the shop having the character currently snapped thereto to appear on the detail information display screen.

In a step 1131, when the user of the portable telephone 1 pushes the numeral key “0”, the transmission function 12 transmits the entered key information to the server.

In a step 2331, the transceiver function 22 receives input information transmitted from the portable telephone 1, and transmits an instruction corresponding to the character operation entered by the user from the portable telephone 1 as event information to the map information display device 301.

The server first searches the character number list information 213 to acquire the character number 2131 corresponding to the user's character, and also searches the display device number list information 211 to acquire the display device number 2111 corresponding to the map information display screen.

And the server 2 acquires the position information (e.g., “up”, “down”, “left”, or “right”) of the detail information display screen with respect to the map information display screen previously stored in the server.

The transceiver function 22 of the server 2 transmits the character number and the position of the detail information display screen to a display device for showing the acquired display device number, that is, to the map information display device 301.

At this time, the transmission data is transmitted with a format (for example, of (character detail information screen shift, character number, detail information screen position) as event information.

In a step 3331, the transceiver function 32 receives, from the server 2, the event information relating to a shift of the character to the detail information display screen, and calculates positional data about a move destination of the character for move and display of the character, on the basis of the current character position and the received position of the detail information display screen.

For example, when the current display position of the character is (250, 300) and the position of the detail information display screen acquired from the server 2 in the step 3331 is “right”, that is, the map information display screen is installed at the right side of the map information display screen; the positional data about the move destination of the character is (1,280, 300). In this case, “1,280” corresponds to an X coordinate at the right end of the map information display screen. In other words, this means that the character has been moved horizontally toward the right side.

It is assumed in the present embodiment that the character is horizontally or vertically moved on the map information display screen to calculate positional data about the move destination. However, the positional data on the move destination on the map information display screen may be calculated taking the move destination of the character on the detail information display screen into consideration.

In a step 3332, the display function 34 starts the move display animation of the character and continues it until the character arrives at the move destination position acquired in the step 3331 from the currently-snapped position of the character.

In this connection, the character may be moved linearly as shown in FIG. 6 or may be moved in a free manner. Through the move display animation function, the character can be continuously moved on the display screen. A program for the move display animation may be previously held (stored) in each display device or may be transmitted from the server 2 to each display device.

In a step 3333, when the character reaches the move destination, the map information display device completes the move display of the character, and displays the detail information on the detail information display screen. And the transceiver function 32 transmits a character number indicative of the character move display completion to the server 2 to inform the server 2 of the fact that the user can start the move display of the character on the detail information display screen.

At this time, the transmission data is transmitted with a format (e.g., of (character detail information screen move completion, character number) as event information.

In a step 2332, the server 2 receives the event information sent in the step 3333 from the map information display screen, searches the display device number list information 211 to acquire the display device number 2111 corresponding to the detail information display screen, and transmits detail information managed in the server about the character-attached shop number to the acquired display device.

At this time, the transmission data is transmitted as event information with a format (for example, of (detail information display, shop number, shop type, shop name, address, telephone, coupon detail information, operating day, shop logo, detail image).

In this connection, the shop log and the detail image may be a URL indicative of a location where an image fir or a video file is placed or may be actual data.

The detail information of the shop is not limited to the data contents included in the event information, but may include web page and electronic mail address of the shop, comment from the shop and video information.

In a step 3334, the detail information display device 302 receives the event information of detail information display sent from the server 2 in the step 2332 through the transceiver function 32, and displays the detail information of the shop through the display function 34.

FIG. 7 shows an example of display of the detail information on the shop.

In a step 2333, in order to cause the character having been moved and displayed on the map information display screen to log in on the detail information display screen and to provide an instruction to the detail information display screen to cause the character to be moved as far as the character display area of the detail information display screen and displayed. The server transmits a character number for log in on the detail information display screen to the detail information display device.

At this time, the transmission data is transmitted as event information with a format (for example, of (detail information screen character log-in, character number, character image file, detail information screen position).

In this connection, the character image file may indicate an URL where image data is stored or may be actual data.

In a step 3335, the display device receives the event information relating to the log-in of character on the detail information display screen through the transceiver function 32 from the server 2, and calculates positional data for character log-in and positional data about the move destination of the character to move and display the character on the basis of the received detail information screen position.

For example, when the position of the detail information display screen acquired from the server 2 in the step 3335 is “right”, that is, when the map information display screen is installed at the right side of the map information display screen; the log-in position of the character is (0, 384). And when a display area for the character is previously decided and when there is currently no character which already logs in on the same detail display screen, the move destination is calculated, for example, to be (1,200, 740) so that the character is displayed sequentially from the right end of the character display area. When the character already logs in on the detail information display screen, it is preferable that the instruction of the character move from the portable telephone 1 be transmitted not to the map information display screen but to the detail information display screen via the server. As a result, the user can shift the character on the detail information display screen.

Although the long-in position of the character has been assumed to be a midpoint of a left side of the display screen in a vertical direction, positional data of the log-in of the character on the detail information display screen may be calculated taking the move and display on the map information display screen into consideration.

Further, the character display on the detail information display screen may be assumed to be only in a predetermined character display area, and the character may be logged in on and displayed in the character display area without the move display animation.

In a step 3336, the display function 34 starts the move display animation and continues the animation until the character arrives at the move destination position acquired from the log-in position of the character in the step 3335.

The character may be moved linearly as far as the move destination as shown in FIG. 7, or may be moved in a free manner.

Through the above steps, the detail information of the shop on the map information display screen can be displayed on the detail information display screen, and the character on the map information display screen can be shifted to the detail information display screen and displayed thereon.

The screens of a plurality of display devices may display an identical type of contents. For example, a plurality of such map information display screens are installed so that such an object as a character is continuously moved here and there on the plurality of map information display screens, or a message from the user is continuously moved and displayed on the plurality of screens as character information (or image information), for example, may be displayed to be moved from right to left.

The system of present invention employing an effective technique can be applied to a wide range of fields. In particular, in a station or a location having many people and business and commercial facilities; a map information display screen for displaying a peripheral map, an advertisement information display screen for displaying advertisement or guidance of shops on the map, a detail information display screen for displaying detail information about shops on the map, and so on can be installed. When the user operates the character on the map information display screen using the portable telephone to move the character here and there between shops on the map information display screen and shift it between the plurality of display screens, e.g., between the map and detail information display screens. And when the user wants to see detail information about a favorite shop, the detail information on the shop can be displayed on the detail information display screen. Further, when the user shifts the character from the map information display screen to the detail information display screen, the detail information of the shop can be displayed with a visual effect.

It should be further understood by those skilled in the art that although the foregoing description has been made on embodiments of the invention, the invention is not limited thereto and various changes and modifications may be made without departing from the spirit of the invention and the scope of the appended claims.

1. A display system comprising:
a first display device;
a second display device for displaying information associated with display contents displayed on said first display device; and
a server for controlling said first display device and said second display device,
wherein said server generates operational information about an object on a display screen of said first display device according to an instruction from a terminal of a user and transmits the operational information of said object to said first display device, said first display device operates said object on the display screen of said first display device and transmits an operation completion notification of said object to said server when operation of said object is completed, said server, when receiving the operation completion notification of said object, transmits information associated with display contents displayed on said first display device to said second display device, and said second display device displays, on a display screen of said second display device, the information associated with the display contents displayed on the display screen of said first display device.

2. A display system according to claim 1, wherein said server decides a move direction of said object on the display screen of said first display device on the basis of a positional information of said object on the display screen of said first display device and a relative positional information of said second display device to said first display device and generates operational information about said object including the move direction of said object, and the move direction of said object is a direction when said object moves on the display screen of said first display device toward a side of the display screen on which said second display device is installed.

3. A display system according to claim 2, wherein said first display device continuously moves said object in the move direction of said object on the display screen of said first display device, and said first display device decides that operation of said object was completed when said object moves on the side of the display screen of said first display device and arrives at an end of the display screen at which side said display device is installed.

4. A display system according to claim 1, wherein said server decides a position of a move destination of said object on the display screen of said first display device on the basis of the positional information of said object on the display screen of said first display device and relative positional information of said second display device to said first display device and generates operational information about said object including information about the position of the move destination of said object, and the position of the move destination of said object is on the display screen of said first display device and in a region of the side of the display screen at which side said second display device is installed.

5. A display system according to claim 4, wherein the region of the side of the display screen at which said second display device is installed is on the display screen of said first display device and at the end of the display screen at which side said second display device is installed.

6. A display system according to claim 4, wherein said first display device continuously moves said object on the display device of said first display device as far as the region of the side of the display screen at which side said second display device is installed, and said first display device decides that operation of said object was completed when said object reaches the region of the side of the display screen of said first display device at which side said second display device is installed.

7. A display system according to claim 1, wherein said first display device, while said second display device displays the information associated with the display contents displayed on said first display device, puts said object in its no display state on the display screen of said first display device, said server transmits said object and the operational information about said object together with the information associated with the display contents displayed on said first display device to said second display device, and said second display device displays said object together with the information associated with the display contents displayed on said first display device and operates said object on the display screen of second display device according to the operational information about said object.

8. A display system according to claim 1, wherein said first display device displays a map, and said second display device displays detail information about one of shops to which said object is snapped on said map as the information associated with the display contents displayed on said first display device.

9. A display device for displaying information according to an instruction from a server, comprising:
a reception unit for receiving operational information about an object on a display screen of said display device from said server when said server causes information associated with display contents displayed on said display device to be displayed on another display device according to an instruction from a user;
a processing unit for operating said object on the display screen of said display device according to the operational information on said object; and
a transmission unit for transmitting an operation completion notification of said object to said server when operation of said object was completed,
wherein said server, when receiving the operation completion notification of said object, transmits the information associated with the display contents displayed on said display device to said another display device, and said other display device displays the information associated with the display contents displayed on said display device.
